(19) United States
(12) Patent Application Publication
(10) Pub. No.: US 2026/0326135 A1
(43) Pub. Date: Oct. 22, 2026

(54) LINE MARKING APPARATUS WITH PAINT FILL LEVEL AND/OR PAINT NOZZLE CONTROL

(71) Applicant: TinyMobileRobots ApS, Malling (DK)

(72) Inventors: Rudi Hansen, Galten (DK); Christoffer Mose, Marslet (DK); Peter Jensen, Skanderborg (DK); Jens Peder Kvols Kristensen, Malling (DK)

(21) Appl. No.: 19/119,378

(22) PCT Filed: Oct. 9, 2023
(86) PCT No.: PCT/EP2023/077944

§ 371 Date: Apr. 8, 2025

(30) Foreign Application Priority Data
Oct. 10, 2022 (DK) PA202200916

(51) Int. Cl. B05B 13/00; A63C 19/06; B05B 12/00; B05B 12/08

(52) U.S. Cl. CPC B05B 13/005; A63C 19/065; B05B 12/004; B05B 12/081; A63C 2019/067

(57) ABSTRACT

A line marking apparatus, such as a mobile marking robot, has a chassis, a spray means with a spray nozzle, and a paint reservoir operably connected to the spray means, thereby allowing paint from the paint reservoir to exit the spray nozzle. The apparatus includes paint fill level and/or paint nozzle control. The line marking apparatus can be stopped when a refill of paint is needed or when the spray nozzle is not operating properly, without requiring a reset of the painting/marking task. The line marking apparatus may be configured to halt automatically or send an alarm to a user to halt the apparatus.

### TECHNICAL FIELD OF THE INVENTION

The present invention relates to line marking apparatuses adapted for marking or painting a surface.

### BACKGROUND OF THE INVENTION

Mobile robots are now used as line marking apparatuses for marking surfaces. The mobile robot replaces tedious and hard manual marking operations done today, e.g., at construction sites or sports fields, using strings and measurement tapes combined with aerosol cans and handheld markers.

When using an autonomous robot for marking e.g., sports fields, the user often knows approximately, when the robot runs empty for paint, but sometimes the user miscalculates the capacity of the paint left in the paint reservoir, resulting the robot trying to paint several hundred meters without success. In some cases, if the robot is set to mark several fields in a sequence, the user might not discover the mistake before after several fields has not been painted.

Another problem is when the spray tool gets blocked for some reason, such as paint clogging the filters, the solenoid, the nozzles, or the pump head. In this case, the robot will also continue operating as if the marking/painting operation is taking place. The latter problem is impossible for the operator to foresee.

It is an objective of the present invention to provide a line marking apparatus, preferably a mobile marking robot, that solves or at least minimizes the above-mentioned problems.

### DESCRIPTION OF THE INVENTION

One aspect relates to a line marking apparatus, such as a mobile marking robot, comprising:
a chassis;
a spray means comprising a spray nozzle;
a paint reservoir;
a pump unit operably connected to said spray means and said paint reservoir, thereby allowing paint from the paint reservoir to exit said spray nozzle;
a sensor unit adapted to measure the power usage of said pump unit; and
a control unit configured to:
a) operate said pump unit to be in and active state, or in an inactive state;
b) receive data input about the power usage of said pump unit during the pump unit's active state; and
c1) determine the paint level, such as an empty level, in said paint reservoir based on said received data input; and/or
c2) determine if the spray nozzle is operating outside one or more predetermined thresholds, e.g., being partly or completely clogged, based on said received data input.

This configuration result in a line marking apparatus that can be stopped in time, to avoid that the entire painting/marking operation must be reset, if a refill of paint is needed, or if the spray nozzle is not operating properly.

The line marking apparatus may be configured to halt automatically or send an alarm to a user to halt the apparatus, if a refill of paint is needed, or if the spray nozzle is not operating properly.

The line marking apparatus is preferably wheeled, such as a mobile marking robot, or a wheeled cart, such as e.g., a wheeled line marker. A line marker is a device or machine with which lines or markings are drawn on a sports field or pitch.

The term “chassis” is used herein to refer to at least a part of the main framework of the line marking apparatus, such as the main framework of a mobile marking robot.

The term “spray nozzle” is defined to be a nozzle, an orifice, a spray valve, a pressure reducing tubing section, and any combination thereof.

In one or more embodiments, the control unit is configured to:
c1) determine the paint level, such as an empty level, in said paint reservoir based on said received data input; and
d) deactivate said pump unit if the paint level in said paint reservoir is determined to be below a predetermined threshold.

In one or more embodiments, the control unit is configured to:
c1) determine the paint level, such as an empty level, in said paint reservoir based on said received data input; and
e) instruct the drive system to stop the movement of the line marking apparatus if the paint level in said paint reservoir is determined to be below a predetermined threshold.

In one or more embodiments, the control unit is configured to:
c2) determine if the spray nozzle is operating outside one or more predetermined thresholds, e.g., being partly or completely clogged, based on said received data input; and
d) deactivate said pump unit if said spray nozzle is determined to operate outside one or more predetermined thresholds.

In one or more embodiments, the line marking apparatus is a mobile marking robot, wherein the line marking apparatus further comprises a drive system, and wherein said control unit is configured to:
c2) determine if the spray nozzle is operating outside one or more predetermined thresholds, e.g., being partly or completely clogged, based on said received data input; and
e) instruct the drive system to stop the movement of the line marking apparatus if said spray nozzle is determined to operate outside one or more predetermined thresholds.

In one or more embodiments, the spray means further comprises a return line through which paint can recirculate from a position upstream to the spray nozzle outlet and back to the paint reservoir, and wherein said control unit is configured to:
c3) instruct said spray means to operate in a de-aeration/degassing mode;
c4) determine if the paint has been properly de-aerated/degassed by being recirculated through said return line based on said received data input, and
c5) instruct said spray means to stop said de-aeration/degassing mode when the paint is determined to be de-aerated/degassed to a predetermined threshold level.

In one or more embodiments, the control unit is configured for running a calibration program including the steps of:
i) instructing a user to fil the paint reservoir to a first fill level being below the full fill level, where the first fill level may be the level corresponding to an empty paint reservoir;
ii) operate the pump unit to be in and active state for a predetermined period of time;
iii) receive data input about the power usage of said pump unit during the pump unit's active state and aligning said received data with the current fill level;
iv) operate the pump unit to be in and inactive state;
v) repeating steps i)-iv) one or more times at different fill levels being below the full fill level; and
vi) repeating steps i)-iv) one or more times at a fill level being at the full fill level.

When the line marking apparatus is a mobile marking robot, it will need to have a localization system telling the robot where it is, and how it is orientated, to be able to mark the data in an area. Furthermore, the data needs to be aligned to the locations system used by the robot. Most common used technologies for positioning are total stations and GNSS, but some solutions use advanced localization technologies together with cameras or lidars.

The orientation of the mobile marking robot can be determined by having two independent location systems placed apart with enough distance to allow the robot to calculate its orientation. Another method of orientation is to let the robot drive a certain distance with one location system, and by driving, it can calculate its orientation. Aligning the robot's localization with the digital data provided requires a shared coordinate system.

If the location system is global, like the GNSS, the global coordinates are sufficient for aligning the data and letting the robot start working.

In one or more embodiments, the positioning system is configured for continuously receiving a positioning signal from a Global Navigation Satellite System (GNSS). Global Navigation Satellite Systems (GNSS) is a collective term for a variety of satellite navigation systems, which use orbiting satellites as navigation reference points to determine position fixes on the ground. GNSS includes the Global Positioning System (GPS), the Global Navigation Satellite System (GLONASS), the Compass system, Galileo, and several Satellite based augmentation systems (SBAS). In typical civilian applications, a single GNSS receiver can measure a ground position with a precision of about ten meters. This is, in part, due to various error contributions, which often reduce the precision of determining a position fix. For example, as the GNSS signals pass through the ionosphere and troposphere, propagation delays may occur. Other factors, which may reduce the precision of determining a position fix, may include satellite clock errors, GNSS receiver clock errors, and satellite position errors. One method for improving the precision for determining a position fix is Real-Time Kinematic (RTK) GNSS. Real Time Kinematic (RTK) satellite navigation is a technique using the phase of the signal's carrier wave, rather than the information content of the signal, and relies on a single reference station or interpolated virtual station to provide real-time corrections.

In one or more embodiments, the positioning system is configured for continuously receiving a positioning signal from a total station. The total station needs to use fix points to calculate its own position as well as the position of the mobile robot. The fix points can be reflectors placed beforehand at known coordinates or it can be fixed points in the construction like corners of walls or windows, that has known coordinates and can be used to localize the total station. The mobile marking robot may comprise a retroreflector. Any retroreflector with retroreflectors, generally known within the art of land surveying, may be used. In one or more embodiments, the retroreflector is a 360-degree all-around retroreflector.

In one or more embodiments, the positioning system is positioned on an elongate member extending upward from the chassis. In one or more embodiments, the elongate member is height adjustable, e.g., comprising telescoping elongate members, or the like.

If the localization system is cameras or lidars, several methods can be used. A common method is to let the robot move around and generate a map of the area. This map can then be used for positioning the robot.

In one or more embodiments, the spray means comprises an airbrush-based spray tool.

In one or more embodiments, the spray means comprises an inkjet-based spray tool, preferably based on a drop-on-demand technology.

In one or more embodiments, the spray means comprises a tool comprising an array of spray nozzles, such as 2-100 spray nozzles, preferably arranged either in a direction along the length of said chassis, or in a direction along the width of said chassis. In one or more embodiments, said tool is adapted for rotating said array of spray nozzles around a common pivot axis, preferably parallel to one or more pivot axes of said robot arm.

In one or more embodiments, the chassis comprises two differentially driven wheel in a fixed orientation and arranged on the same first axis line in parallel; and one off-centered orientable wheel arranged along a second axis line perpendicular to the first axis line, and in front or behind the first axis line.

The term “off-centered wheel” (castor wheel) is defined to be a wheel, where the vertical axis does not pass through the center of the wheel but is slightly off-centered. Some designs include a swivel joint (orientable) between the wheel and the fork so that it can rotate freely with 360° of freedom. The advantage with an off-centered orientable wheel compared to a centered orientable wheel is that the centered orientable wheel tends to lock in specific positions.

The mobile marking robot comprises a paint reservoir. The paint reservoir may be configured as a bag-in-box type reservoir, or simply as a replaceable bag reservoir, or a replaceable box reservoir.

In one or more embodiments, the spray means further comprises a return line through which paint can recirculate from a position upstream to the spray nozzle outlet and back to the paint reservoir. This configuration removes air from the paint and tubing, such that the spray nozzle will not splutter when painting a line.

In one or more embodiments, the spray means comprises means adapted for adjusting the drive mechanism and/or spray nozzle position in the vertical direction relative to the ground surface on which the mobile marking is robot moving.

In one or more embodiments, the spray means comprises a mechanism, such as a telescopic arm or the like, adapted for lowering and raising said spray nozzle(s) relative to the surface on which the mobile marking robot is moving. In one or more embodiments, the mobile marking robot further comprises a sensor configured for continuously determining the distance between said spray nozzle(s) and said surface, and wherein said control unit is configured to receive data about said distance from said sensor and in response thereto, change said distance by activating said mechanism to move said spray nozzle(s) relative to said surface. Distance sensors are well-known within the art and will thus not receive further attention.

In one or more embodiments, the differentially driven wheels are positioned near the rear end of the chassis, and wherein the off-centered orientable wheel is positioned near the front end of the chassis. Preferably, the off-centered orientable wheel is positioned equally distanced from each of the drive wheels.

As an example, an in order for the line marking apparatus/mobile robot to operate, the control unit may comprise a computing system including a processor, a memory, a communication unit, an output device, an input device, and a data store, which may be communicatively coupled by a communication bus. The mentioned computing system should be understood as an example and that it may take other forms and include additional or fewer components without departing from the scope of the present disclosure. For instance, various components of the computing device may be coupled for communication using a variety of communication protocols and/or technologies including, for instance, communication buses, software communication mechanisms, computer networks, etc. The computing system may include various operating systems, sensors, additional processors, and other physical configurations. The processor, memory, communication unit, etc., are representative of one or more of these components. The processor may execute software instructions by performing various input, logical, and/or mathematical operations. The processor may have various computing architectures to method data signals (e.g., CISC, RISC, etc.). The processor may be physical and/or virtual and may include a single core or plurality of processing units and/or cores. The processor may be coupled to the memory via the bus to access data and instructions therefrom and store data therein. The bus may couple the processor to the other components of the computing system including, for example, the memory, the communication unit, the input device, the output device, and the data store. The memory may store and provide data access to the other components of the computing system. The memory may be included in a single computing device or a plurality of computing devices. The memory may store instructions and/or data that may be executed by the processor. For example, the memory may store instructions and data, including, for example, an operating system, hardware drivers, other software applications, databases, etc., which may implement the techniques described herein. The memory may be coupled to the bus for communication with the processor and the other components of computing system. The memory may include a non-transitory computer-usable (e.g., readable, writeable, etc.) medium, which can be any non-transitory apparatus or device that can contain, store, communicate, propagate, or transport instructions, data, computer programs, software, code, routines, etc., for processing by or in connection with the processor. In some implementations, the memory may include one or more of volatile memory and non-volatile memory (e.g., RAM, ROM, hard disk, optical disk, etc.). It should be understood that the memory may be a single device or may include multiple types of devices and configurations. The input device may include any device for inputting information into the computing system. In some implementations, the input device may include one or more peripheral devices. For example, the input device may include the display unit comprising a touchscreen integrated with the output device, etc. The output device may be any device capable of outputting information from the computing system. The output device may be the display unit, which display electronic images and data output by a processor of the computing system for presentation to a user, such as the processor or another dedicated processor. The data store may include information sources for storing and providing access to data. In some implementations, the data store may store data associated with a database management system (DBMS) operable on the computing system. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations. The data stored by the data store may be organized and queried using various criteria including any type of data stored by them. The data store may include data tables, databases, or other organized collections of data. The data store may be included in the computing system or in another computing system and/or storage system distinct from but coupled to or accessible by the computing system. The data stores can include one or more non-transitory computer-readable mediums for storing the data. In some implementations, the data stores may be incorporated with the memory or may be distinct therefrom. The components may be communicatively coupled by the bus and/or the processor to one another and/or the other components of the computing system. In some implementations, the components may include computer logic (e.g., software logic, hardware logic, etc.) executable by the processor to provide their acts and/or functionality. These components may be adapted for cooperation and communication with the processor and the other components of the computing system.

It should be noted that embodiments and features described in the context of one of the aspects of the present invention also apply to the other aspects of the invention.

### BRIEF DESCRIPTION OF THE FIGURES

FIG. 1 shows a flowchart of the movement of paint through a marking apparatus in accordance with various embodiments of the invention.

FIG. 2 shows a control chart on how the control unit is operably connected to individual components of the line marking apparatus in accordance with various embodiments of the invention.

### DETAILED DESCRIPTION OF THE INVENTION

In general, a line marking apparatus, such as a mobile marking robot, comprises a chassis, a spray means comprising a spray nozzle, and a paint reservoir operably connected to the spray means, thereby allowing paint from the paint reservoir to exit the spray nozzle.

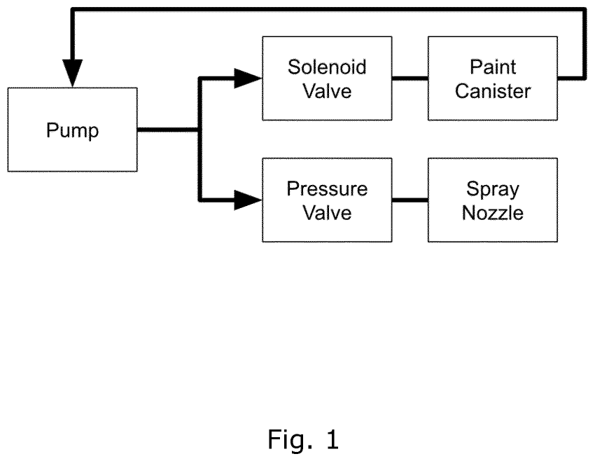

Referring to FIG. 1, a flowchart is depicted of the movement of paint through a marking apparatus in accordance with various embodiments of the invention. Paint is always moved from the paint reservoir (Paint canister) and through the pump unit (Pump). From here, two paths may be possible. The first path is when the paint is pumped through the spray nozzle, e.g., via a pressure regulating valve (Pressure valve). The pressure regulating valve may either be automatically, e.g., via the control unit, or manually controlled/adjusted. The second path may be present when the spray means further comprises a return line through which paint can recirculate from a position upstream to the spray nozzle and back to the paint reservoir (Paint canister), e.g., via a solenoid valve. This configuration removes air from the paint and tubing, such that the spray nozzle will not splutter when painting.

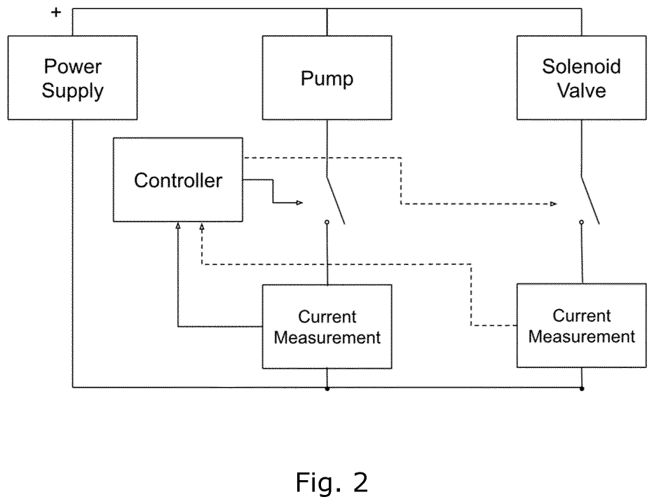

Referring to FIG. 2, a control chart is depicted of how the control unit may be operably connected to individual components of the line marking apparatus in accordance with various embodiments of the invention. The control unit (Controller) is configured to receive data input about power usage from two sensor units (Current Measurement). When the first path (see above) is active, a first circuit has been activated, e.g., via an N-Channel MOSFET switch, by the control unit (Controller). A power supply (Power Supply), e.g., a 24V switch-mode buck converter, secures a fixed power supply through the first circuit to the pump unit (Pump). The circuit current may be measured by different methods, such as with a current detection circuit, e.g., including a shunt resistor, a differential amplifier, and an analogue to digital converter. If the paint is air-filled, or the paint reservoir is empty, the pump unit has been found to use relatively less power to run compared to normal operation. Similarly, it has been found that if the paint nozzle is clotted, the pump unit uses more power to run compared to normal operation (e.g., compared to a pre-set power usage). Similarly, when the second path (see above) is active, a second circuit has been activated, e.g., via an N-Channel MOSFET switch, by the control unit (Controller). Measuring the pump power usage in this circuit can be used for checking if the line marking apparatus is operating in the correct mode, to check when the paint has been properly de-aerated/degassed, or as a baseline check, if a clotting error or an empty paint reservoir error has been registered via the first circuit. E.g., if a clotting error has been registered, the second path may be activated to check if the pump operates normally in this mode. If that is the case, then it is confirmed that the pump is operating differently from a normal mode, e.g., a pre-set normal power consumption mode, due to clotting of the paint nozzle. If the pump is registered not to be operating normally, then the error may be due to a pump malfunction.

1. A line marking apparatus, such as a mobile marking robot, comprising:
a chassis;
a spray means comprising a spray nozzle;
a paint reservoir; and
a pump unit operably connected to said spray means and said paint reservoir, thereby allowing paint from the paint reservoir to exit said spray nozzle;
wherein said marking apparatus further comprises:
a sensor unit adapted to measure the power usage of said pump unit; and
a control unit configured to:
a) operate said pump unit to be in and active state, or in an inactive state;
b) receive data input about the power usage of said pump unit during the pump unit's active state; and
c1) determine the paint level, such as an empty level, in said paint reservoir based on said received data input; and/or
c2) determine when the spray nozzle is operating outside one or more predetermined thresholds, such as being partly or completely clogged, based on said received data input.

2. The line marking apparatus according to claim 1, wherein said control unit is configured to:
c1) determine the paint level in said paint reservoir based on said received data input; and
d) deactivate said pump unit when the paint level in said paint reservoir is determined to be outside one or more predetermined thresholds.

3. The line marking apparatus according to claim 1, wherein the line marking apparatus is a mobile marking robot, wherein the line marking apparatus further comprises a drive system, and wherein said control unit is configured to:
c1) determine the paint level in said paint reservoir based on said received data input; and
e) instruct the drive system to stop the movement of the line marking apparatus when the paint level in said paint reservoir is determined to be outside one or more predetermined thresholds.

4. The line marking apparatus according to claim 1, wherein said control unit is configured to:
c2) determine when the spray nozzle is operating outside one or more predetermined thresholds, e.g., being partly or completely clogged, based on said received data input; and
d) deactivate said pump unit if when said spray nozzle is determined to operate outside one or more predetermined thresholds.

5. The line marking apparatus according to claim 1, wherein the line marking apparatus is a mobile marking robot, wherein the line marking apparatus further comprises a drive system, wherein said control unit is configured to:
c2) determine when the spray nozzle is operating outside one or more predetermined thresholds, e.g., being partly or completely clogged, based on said received data input; and
e) instruct the drive system to stop the movement of the line marking apparatus when said spray nozzle is determined to operate outside one or more predetermined thresholds.

6. The line marking apparatus according to claim 1, wherein the spray means further comprises a return line through which paint can recirculate from a position upstream to the spray nozzle outlet and back to the paint reservoir, and wherein said control unit is configured to:
c3) instruct said spray means to operate in a de-aeration/degassing mode;
c4) determine when the paint has been properly de-aerated/degassed by being recirculated through said return line based on said received data input, and
c5) instruct said spray means to stop said de-aeration/degassing mode when the paint is determined to be de-aerated/degassed to a predetermined threshold level.

7. The line marking apparatus according to claim 1, wherein said control unit is configured for running a calibration program including the steps of:
i) instructing a user to fill the paint reservoir to a first fill level being below the full fill level, where the first fill level may be the level corresponding to an empty paint reservoir;
ii) operate the pump unit to be in and active state for a predetermined period of time;
iii) receive data input about the power usage of said pump unit during the pump unit's active state and aligning said received data with the current fill level;
iv) operate the pump unit to be in and inactive state;
v) repeating steps i)-iv) one or more times at different fill levels being below the full fill level; and
vi) repeating steps i)-iv) one or more times at a fill level being at the full fill level.
